(19) United States
(12) Patent Application Publication
(10) Pub. No.: US 2009/0327399 A1
(43) Pub. Date: Dec. 31, 2009

(54) Device and method for managing the availability of access to digital data

(76) Inventors: Guillaume Dorbes, Nozay (FR); Cyril Hue, Nozay (FR); Claire Bazin, Nozay (FR)

Correspondence Address: HARNESS, DICKEY & PIERCE, P.L.C., P.O. BOX 8910, RESTON, VA, 20195, US

(21) Appl. No.: 12/453,368

(22) Filed: May 8, 2009

(30) Foreign Application Priority Data
May 14, 2008 (FR) 0802613

(51) Int. Cl. G06F 15/16

(52) U.S. Cl. 709/202; 709/206

(57) ABSTRACT

The invention pertains to a device for managing the availability of digital data (7) accessible over a computer network (3), comprising means for:

saving (71) at least one digital data address (www.serv-i.com) whose access availability must be determined, this address being associated with a contact (Agent i) saved in a user's instant messaging application;

automatically determining (72) the availability of access to said digital data by means of the computer network (3);

sending an availability indicator of said associated contract to the user's instant messaging presence manager (8).

The invention pertains to users' access to digital data by means of computer networks.

In order to access digital data (particularly multimedia content) by means of a computer network, a user traditionally uses an Internet browser, into which he enters an address in the form of a URL. DNS servers convert the entered URL into an IP address. The requested digital data is saved on a server that may be accessed over the computer network at that IP address. The digital data may be downloaded, or reproduced using a streaming technique.

Such a mode for accessing digital data, however, has drawbacks. As the availability of the digital data is not permanent, the user may experience an unavailability of this data during an access attempt, which may lead him to stop trying to access this data. Additionally, depending on the traffic to this digital data, the bandwidth available to the user may temporarily prove insufficient.

The invention aims to resolve one or more of these drawbacks. In particular, the invention aims to enable the user to know the availability of digital data located on a remote server by means of an application frequently used at his terminal. The invention thereby pertains to a device for managing the availability of digital data accessible over a computer network, comprising means for:
saving at least one digital data address, whose availability for access must be determined, this address being associated with a contact saved within a user's instant messaging application;
determining the availability of access to said digital data by means of the computer network;
sending an availability indicator of said associated contract to a presence management device of the user's instant messaging application

In one variant, said means are adapted to enable a user to enter an identifier for the contact associated with said address, and are adapted to save said identifier in connection with the saved address.

In a further variant, said contact's identifier is a URI.

In another variant, said means are adapted to log in to an instant messaging presence management server with the identifier of the contact associated with said address, and are adapted to then send the availability indicator to that presence management server.

In yet another variant, said means are adapted to log in to the presence server and to send it said contact's availability indicator after the detection of a change in the availability of the digital data at said address.

In one variant, said means are adapted to determine the availability of access to said digital data at regular intervals.

In another variant, said digital data is multimedia data.

In a further variant, said availability indicator complies with the IP Multimedia Subsystem standards.

The invention also pertains to a server accessible to an instant messaging application by means of a computer network, comprising a device such as the one described above.

The invention further pertains to an instant messaging application that may save a digital data address provided by a user and create a contact associated with that address, connect to an availability management device of the digital data, save the address of the digital data and the contact created in the availability management device, connect to a presence management device of the instant messaging application and therein save the contact created as a user of instant messaging, whenever this application is run on a computer.

The invention further pertains to a method for determining the availability of digital data accessible over a computer network, comprising the steps of:
saving a digital data address whose availability must be determined, and an instant messaging contact associated with that address;
automatically determining the availability of access to said digital data over the computer network;
sending an availability indicator of the associated contact to a presence manager of an instant messaging application.

In one variant, the method comprises the generating of the digital data address and the associated contact in a user's instant messaging application, and the displaying of the associated contact's availability in the user's instant messaging application after determining the availability of access to the digital data.

In a further variant, the user's instant messaging application connects to the presence manager by means of the computer network in order to read the associated contact's availability indicator.

In another variant, the user's instant messaging application saves the associated contact in the presence manager.

In yet another variant, the sending of the availability indicator is preceded by logging in to the presence manager as the associated contact.

Other characteristics and advantages of the invention shall become clear upon reading the description below, given by way of a non-limiting example, with reference to the attached drawings, in which:

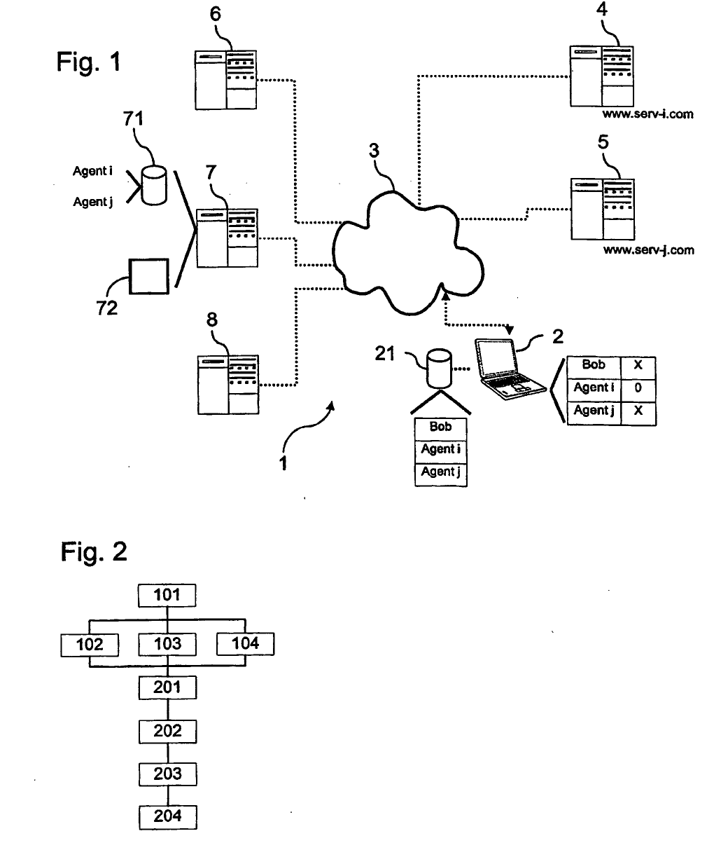

FIG. 1 is a schematic diagram of a system implementing the invention;

FIG. 2 depicts a process for managing the availability of the digital data.

The invention allows a user to track the availability of digital data accessible over a computer network by means of an instant messaging application. The address of the digital data is associated with a virtual contact in the instant messaging application. After having determined the availability of access to the digital data at that address, an availability indicator is sent to an instant messaging presence manager of the user.

FIG. 1 schematically depicts one embodiment of a system 1 implementing the invention. The system 1 includes a terminal 2 of a user. The terminal 2 is connected to a computer network, such as the Internet. The user of terminal 2 may communicate with servers 4 and 5, which give access to digital data by means of the network 3. The digital data saved by these servers 4 and 5 is accessible by using their URL. The home pages of the websites hosted by servers 4 and 5 are respectively found at the URLs www.serv-i.com and www.serv-j.com. The digital data at said addresses may be static, such as files for download, or dynamic, such as television programs which are broadcast and which change over time. The digital data may be intended to be broadcast to a large number of users.

At his terminal 2, by means of his instant messaging application, the user sees the availability of another user, “Bob”, and of digital data saved in the servers 4 and 5. The user “Bob” and the saved digital data are declared in the form of contacts in the instant messaging application. These contacts are saved in a database 21 of the terminal. Digital data accessible at a given address on the server 4 is declared as a contact “Agent i” in the database 21. Digital data accessible at a given address on the server 5 is declared as a contact “Agent j” in the database 21. In the example, a graphical interface shows the contacts, with an availability indicator, to the user of the terminal 2. An X indicates presence or availability, while an O indicates the contact's absence or unavailability.

For a file to which access is requested by means of the network 3, different types of availability indicators may be used. An availability indicator may indicate that the file is available for the user to download, another availability indicator may indicate that the file is available under access conditions (such as a pay-to-download file), and another availability indicator may indicate that the file is unavailable. An indicator may also indicate that the file is accessible locally for the user. Distinct symbols may be associated with various availability indicators, such as by using color-codes displayed on the user's terminal 2. Displaying an orange symbol could mean that the file is available for download, displaying a red symbol could mean that the file is available under certain conditions, displaying a black symbol could mean that the file is unavailable, and displaying a green symbol could mean that the file has been downloaded or is available locally.

The availability indicator could also provide information regarding the conditions for accessing digital data, such as by indicating whether traffic to this data is normal, disrupted, or indeterminate.

For digital data simultaneously broadcast to different users, such as television programs, different availability indicators may be considered. An indicator could indicate that the program is pay-to-view, another indicator could indicate that the availability of the program is not monitored, another indicator could indicate that the program is currently being broadcast, and another indicator could indicate that a commercial break in the program is currently being broadcast.

A server 6, in a manner known per se, enables different users to communicate with one another by means of their instant messaging applications. The server 6 may be an XDM (for ‘XML Document Management’) server.

A user availability management server 8, in a manner known per se, enables different users to know the presence status of other users, by means of their instant messaging applications. The server 8 is a presence manager for the instant messaging applications of various users. The user is generally identified in the server 8 by a URI (for Uniform Resource Identifier), such as an e-mail address. Normally, the availability of a user is determined automatically by his instant messaging application, such as by detecting the use of the user's terminal's keyboard or mouse. The instant messaging application of the terminal 2 communicates with the server 8 in order to indicate to it the availability of the user. The server 8 saves an availability indicator for the various users. For the other users declared as contacts in a user's instant messaging application, this application retrieves their availability indicators from the server 8. According to the invention, the server 8 also saves an availability indicator for the various digital data declared in the form of contacts in the users' instant messaging applications. Whenever the terminal 2 is connected to the network 3 and its instant messaging application is running, the availability of the digital data that it declared as contacts is checked by consulting the server 8.

The server 8 may also manage the users' registration for the instant messaging service, and the users' registration for the digital data availability tracking service.

A server 7 is accessible by means of the network 3. The server 7 is capable of saving a list of monitoring entities in a database 71. Each monitoring entity corresponds to digital data that a user has declared as a contact in his instant messaging application. The database 71 thereby contains a monitoring entity ‘Agent i’ for data at the address www.serv-i.com and a monitoring entity ‘Agent j’ for the data at the address www.serv-j.com. For each monitoring entity, an availability search is carried out at regular intervals using a test module 72 of the server 7. At regular intervals, the test module 72 tests the availability of the data at an address saved in the list, and records the results of the test in the database 71. The availability test may be carried out by sending a ‘Get’ command, which is a REST request (for Representational State Transfer) that is standardized in Internet architectures.

The monitoring entities may be entered into the database 71 by users, either from their instant messaging applications, or directly using an application accessible online. For each monitoring entity entered into the database 71, a corresponding contact is saved in the server 8 in order to publish its availability status. Each monitoring entity may be represented by a unique URI. The server 7 may send the user a return receipt for the creation of a monitoring entity.

Availability test parameters may be defined when the user registers, or may be edited at a later time. These parameters may be defined in the server 7 directly by the user, or defined by the user in the server 8, then saved in the server 7. The test parameters may include the name given to the monitoring entity, the frequency of availability tests, etc.

The results of the availability tests of the monitoring entities saved in the database 71 are published in the server 8 every time the availability of the corresponding digital data changes. In this manner, whenever the instant messaging application consults the server 8 in order to tell the availability status of digital data, an updated availability indicator is published for the corresponding contact.

As the operating principle of instant messaging applications assumes that these applications are running for the majority of the time that the terminal is being used by their user, the user will constantly have information on the availability of the digital data that he wishes to track, from an application which he is already accustomed to using.
FIG. 2 depicts an example process for managing the availability of the digital data. During a step 101, the user requests the creation of a new contact, and by means of his instant messaging application, enters a digital data address whose availability must be determined. The user also enters a URI identifier for the new contact associated with the digital data address. During a step 102, the user registers the new contact on the server 8 for the digital data located at the address on the network. During a step 103, the address of the data and the identifier of the new contact are saved in database 71 on server 7. During a step 104, the new contact is saved in the user's instant messaging application's address book.

During a step 201, the test module 72 checks the availability of the digital data at the address saved for the new contact. During a step 202, the server 7 connects to the server 8 as a new contact. The server 7 sends an availability indicator for the new contact to the server 8. The new contact's availability indicator is thereby published in the server 8. During a step 203, the instant messaging application connects to the server 8 and checks the availability for the new contact. During a step 204, the instant messaging application displays the availability status of the digital data with a visual indicator associated with the new contact.

1. A management device for managing the availability of digital data accessible over a computer network, wherein the management device comprises means for:
saving at least one digital data address whose access availability must be determined, this address being associated with a contact saved in a user's instant messaging application;
automatically determining the availability of access to said digital data by means of the computer network;
sending an availability indicator of said associated contract to the user's instant messaging presence manager.

2. A device according to claim 1, wherein said means are adapted to enable a user to enter an identifier for the contact associated with said address, and are adapted to save said identifier in connection with the saved address.

3. A device according to claim 2, wherein said contact's identifier is a URI.

4. A device according to claim 2, wherein said means are adapted to log in to an instant messaging presence management server with the identifier of the contact associated with said address, and are adapted to then send the availability indicator to that presence management server.

5. A device according to claim 4, wherein said means are adapted to log in to the presence server and to send it said contact's availability indicator after the detection of a change in the availability of the digital data at said address.

6. A device according to claim 1, wherein said means are adapted to determine the availability of access to said digital data at regular intervals.

7. A device according to claim 1, wherein said digital data is multimedia data.

8. A device according to claim 1, wherein said availability indicator complies with the IP Multimedia Subsystem standards.

9. A server accessible for an instant messaging application by means of a computer network, comprising a device according claim 1.

10. An instant messaging application, wherein the application may save a digital data address provided by a user and create a contact associated with that address, connect to an availability management device of the digital data, save the address of the digital data and the contact created in the availability management device, connect to a presence management device of the instant messaging application and therein save the contact created as a user of instant messaging, whenever this application is run on a computer.

11. A method for determining the availability of digital data accessible over a computer network, comprising:
saving a digital data address whose availability must be determined, and an instant messaging contact associated with that address;
automatically determining the availability of access to said digital data over the computer network;
sending an availability indicator of the associated contact to a presence manager of an instant messaging application.

12. A method according to claim 11, comprising the generating of the digital data address and the associated contact in a user's instant messaging application, and the displaying of the associated contact's availability in the user's instant messaging application after determining the availability of access to the digital data.

13. A method according to claim 12, wherein the user's instant messaging application connects to the presence manager by means of the computer network in order to read the associated contact's availability indicator.

14. A method according to claim 12, wherein the user's instant messaging application saves the associated contact in the presence manager.

15. A method according to claim 11, wherein the sending of the availability indicator is preceded by logging in to the presence manager as the associated contact.
